(19) United States
(12) Patent Application Publication
(10) Pub. No.: US 2014/0112135 A1
(43) Pub. Date: Apr. 24, 2014

(54) Communications Method and Equipment

(71) Applicant: Huawei Technologies Co., Ltd., (unknown)

(72) Inventors: Min Huang, Shanghai (CN); Hantao Li, Beijing (CN)

(21) Appl. No.: 14/144,197

(22) Filed: Dec. 30, 2013

Related U.S. Application Data
(63) Continuation of application No. PCT/CN2012/086175, filed on Dec. 7, 2012.

(30) Foreign Application Priority Data
Dec. 13, 2011 (CN) 201110414871.4

(51) Int. Cl. H04W 28/02

(52) U.S. Cl. CPC H04W 28/0289
USPC 370/231

(57) ABSTRACT

The present invention discloses a communications method and equipment and relates to the field of wireless communications, which are used to solve a problem that data offloading communications cannot be initiated because data offloading information of a network transmission peer end in a process of data offloading cannot be acquired in the prior art. A first network element queries data offloading capability information of a second network element from a server, where the first network element has a capability of data offloading. The first network element receives a message that carries the data offloading capability information of the second network element and is sent by the server. The first network element offloadingly transmit data which is to be sent when the message indicates that the second network element has a capability of data offloading.

This application is a continuation of International Application No. PCT/CN2012/086175 filed on Dec. 7, 2012, which claims priority to Chinese Patent Application No. 201110414871.4, filed on Dec. 13, 2011, both of which are hereby incorporated by reference in their entireties.

### TECHNICAL FIELD

The present invention relates to the field of communications, and in particular, to a communications method and equipment.

### BACKGROUND

In the mobile communications market, with the update of a communications technology, an air interface throughput rate, namely, a rate of transmission between nodes during network transmission also increases continuously. However, with the increase of the number of users and the growth of data services, the air interface throughput rate is still a bottleneck. On the other hand, in the prior art, a network transmission technology has a feature of diversity. Therefore, more and more terminal equipments can perform data offloading transmission, that is, for transmitted data, distribute a part of the data through a data offloading function to a network in a non-current mode for synchronous transmission, thereby improving the air interface throughput rate.

But in the prior art, for data offloading, there must be a network or a user equipment supporting the function of data offloading. However, in the prior art, before a network and a user equipment complete data offloading handshaking communications, the network and the user equipment cannot obtain whether the peer end supports a data offloading function, so that a delay of implementation of data offloading transmission is long and efficiency is low.

### SUMMARY OF THE INVENTION

Embodiments of the present invention provide a communications method and equipment, which are used to solve a problem that a delay of implementation of data offloading transmission is long and efficiency is low because a network and a terminal cannot obtain data offloading capability information of each other before the network and the terminal complete data offloading handshaking communications in the prior art.

To achieve the foregoing objectives, the embodiments of the present invention adopt the following technical solutions.

A communications method includes querying, by a first network element, data offloading capability information of a second network element from a server, where the first network element has a capability of implementing data offloading, receiving, by the first network element, a message that carries the data offloading capability information of the second network element and is sent by the server, and offloadingly transmit, by the first network element, data when the message indicates that the second network element has a capability of implementing data offloading.

A communications equipment includes a querying module, configured to query data offloading capability information of a second network element from a server, where the communications equipment has a capability of implementing data offloading, an acquiring module, configured to receive a message that carries the data offloading capability information of the second network element and is sent by the server, and a transmitting module, configured to offloadingly transmit data when the message indicates that the second network element has a capability of implementing data offloading.

A communications method includes receiving, by a server, a message of querying data offloading capability information of a second network element, where the message is sent by a first network element, and the first network element has a capability of implementing data offloading, and sending, by the server, a message of the queried data offloading capability information of the second network element to the first network element, so as to offloadingly transmit data.

A server includes an acquiring module, configured to receive a message of querying data offloading capability information of a second network element, where the message is sent by a first network element, and the first network element has a capability of implementing data offloading, and a sending module, configured to send a message of the queried data offloading capability information of the second network element to the first network element, so as to perform data offloading transmission.

A communications method includes sending, by a first network element, a data offloading request message to a second network element, and offloadingly transmit, by the first network element, data which is to be sent when the first network element receives a data offloading acknowledgement message sent by the second network element.

A communications equipment includes a sending module, configured to send a data offloading request message to a second network element, and a transmitting module, configured to data offloadingly transmit data which is to be sent when the communications equipment receives a data offloading acknowledgement message sent by the second network element.

The embodiments of the present invention provide a communications method and equipment. Data offloading capability information of equipments at two sides of data transmission in a network is acquired through active query, so that the equipments at two sides of data transmission in the network can smoothly perform data offloading transmission through the acquired data offloading capability information, thereby improving an air interface throughput rate of the network.

### BRIEF DESCRIPTION OF THE DRAWINGS

For a more complete understanding of the present invention, and the advantages thereof, reference is now made to the following descriptions taken in conjunction with the accompanying drawings, in which:

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a flow chart of a method according to an embodiment of the present invention;

FIG. 2 is a schematic structural diagram of a communications equipment according to an embodiment of the present invention;

FIG. 3 is a flow chart of another method according to an embodiment of the present invention;

FIG. 4 is a schematic structural diagram of a server according to an embodiment of the present invention;

FIG. 5 is a flow chart of a method according to an embodiment of the present invention;

FIG. 6 is a schematic structural diagram of a communications equipment according to an embodiment of the present invention;

FIG. 7 is a flow chart of another method according to an embodiment of the present invention;

FIG. 8 is a flow chart of another method according to an embodiment of the present invention; and

FIG. 9 is a flow chart of another method according to an embodiment of the present invention.

### DETAILED DESCRIPTION OF ILLUSTRATIVE EMBODIMENTS

The following clearly and describes the technical solutions in the embodiments of the present invention with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

### Embodiment 1

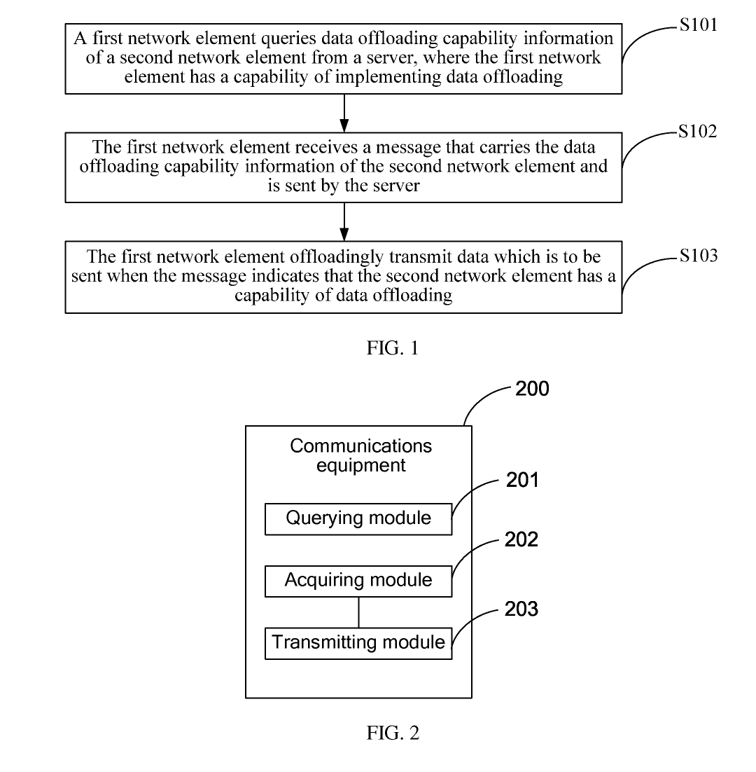

An embodiment of the present invention provides a communications method. The method is a method at a first network element side. As shown in FIG. 1, the method includes:

S101: A first network element queries data offloading capability information of a second network element from a server, where the first network element has a capability of implementing data offloading.

The method in this embodiment is mainly applied to a process that transmission is performed on distributed data between a user equipment and a network equipment. With the increase of traffic of a user, it is difficult to satisfy a demand of the user for a transmission rate by using only a same communications system. Currently, in a scenario of diversified network technologies, some non-3GPP communications systems are also popular with an operator, such as a WLAN (wireless LAN, wireless local area network). In order to improve a network transmission rate, with a method of using different communications systems to offloadingly transmit on a data service, a part of data is distributed to a non-current communications system, so that the data is synchronously transmitted in two types of communications systems, thereby improving the network transmission rate.

In order to implement data offloading transmission, a first network element and a second network element at two sides of data transmission need to have a capability of implementing data offloading, and the first network element and the second network element at the two sides of the data transmission can acquire data offloading transmission capability information of each other. That the first network element and the second network element have a capability of implementing data offloading means that the first network element and the second network element can offloadingly transmit data between a first communications system and a second communications system, so as to distribute a part of data transmitted in the first communications system to the second communications system for synchronous data transmission. The data offloading transmission capability information refers to one of the following or a combination message of the following: enabling status information of a data offloading function, network offloading setting information, and terminal data offloading service IP address or service port number information of the first network element or the second network element.

In this embodiment, when the first communications system is a 3GPP mobile communications system, the second communications system may be a non-3GPP mobile communications system, or optionally, when the first communications system is a 3GPP mobile communications system, the second communications system may be a short-distance wireless communications system, or optionally, when the first communications system is a non-3GPP mobile communications system, the second communications system may be a short-distance wireless communications system.

It can be understood that, the foregoing 3GPP mobile communications network includes a global system for mobile communication (Global System For Mobile Communication, GSM), wideband code division multiple access (Wideband Code Division Multiple Access, WCDMA), time division-synchronous code division multiple access (Time Division-Synchronous Code Division Multiple Access, TD-SCDMA), or long term evolution (Long Term Evolution, LTE) network. The non-3GPP mobile communications network includes worldwide interoperability for microwave access (Worldwide Interoperability for Microwave Access, WiMAX) or code division multiple access (Code Division Multiple Access, CDMA) 2000. The short-distance wireless communications network includes a WLAN, infrared, Bluetooth or zigbee (Zigbee).

In this embodiment, the first network element may be a user equipment, and the second network element may be a network equipment set at an RAN (Radio Access Network, radio access network) side or a network equipment set at a core network side or a network equipment set at a packet data network side. The first network element may also be a network equipment set at an RAN side or a network equipment set at a core network side or a network equipment set at a packet data network side, and the second network element is a user equipment.

When the first network element or the second network element is a user equipment, and the first communications system is a wireless communications system, the user equipment may be located in a macro cell macro cell, a micro cell micro cell, a pico cell pico cell or a femto cell femto cell of the first communications system.

Before the first network element and the second network element perform data offloading transmission, firstly a communications system connection needs to be established between the first network element and the second network element. Exemplarily, when the first network element is a user equipment, the second network element is a network equipment set at an RAN side, after entering a network cell where the second network element is located, the user equipment establishes an EPS (Evolved Packet System, evolved packet system)/SAE (System Architecture Evolution, system architecture evolution) bearer connection with the network cell where the second network element is located.

In this embodiment, a special equipment or a special server may be set in the second network element, or be connected to the second network element. For example, when the first network element is a user equipment, the second network element is a network side equipment set at a network side, and a server that stores data offloading capability information is set in the second network element, after a communications system connection is established between the first network element and the second network element, the first network element may query the data offloading capability information of the second network element from the server. Specifically, the first network element may send an instruction of querying a data offloading capability of the second network element to the server to instruct the server to query the data offloading capability information of the second network element. It may be understood that, when the server has already stored data offloading capability information of the first network element and the data offloading capability information of the second network element, the server may search in its own storage. When the server does not store the data offloading capability information of the first network element and the data offloading capability information of the second network element, the server may send a query instruction to the second network element. The server may be deployed in a PDN (public data network, public data network), and may also be deployed in a CN (Core Network, core network), and is mainly configured to store data offloading capability information of the user equipment and data offloading capability information of the network equipment in a long term. Definitely, in this embodiment, the server may be a module set in a network side equipment. Specifically, when the first network element or the second network element is a network side equipment, the server may be set in the first network element or the second network element. The foregoing setting may also be introduced to subsequent embodiments of the present invention, which is not described subsequently again.

In this embodiment of the present invention, there are mainly two approaches of acquiring the data offloading capability information of the second network element in the server:

A first approach is the data offloading capability information is actively sent to the server by the second network element.

In this acquiring approach, exemplarily, when the second network element is a network equipment set at a radio access network RAN side, and when the second network element completes network deployment, or when a data offloading capability of the second network element changes, the second network element actively sends the data offloading capability information to the server. When the second network element is a user equipment, and when the second network element starts a network function for the first time, or when a data offloading capability of the second network element changes, the second network element actively sends the data offloading capability information to the server.

A second approach is the data offloading capability information of the second network element is sent to the server by the second network element in response to a request.

Specifically, when the server does not include to-be-queried data offloading information of the second network element after the first network element queries the data offloading capability information of the second network element from the server, the first network element or the server may send a request to the second network element, so that the second network element sends the data offloading information of the second network element to the server in response to the request.

S102: The first network element receives a message that carries the data offloading capability information of the second network element and is sent by the server.

After obtaining, through querying, the data offloading capability information of the second network element, where the data offloading capability information needs to be queried by the first network element, the server sends the data offloading capability information of the second network element to the first network element in a message form. The first network element determines, according to the received data offloading capability information of the second network element, whether to perform data offloading transmission on data.

S103: The first network element performs offloading transmission on data when the message indicates that the second network element has a capability of implementing data offloading.

When the data offloading capability information of the second network element received by the first network element indicates that the second network element has a data offloading capability, the first network element may start to perform offloading transmission on the data according to enabling status information of a data offloading function, network offloading setting information, and a terminal data offloading service IP address or a service port number information in the data offloading capability information of the second network element.

When the data offloading capability information of the second network element received by the first network element indicates that the second network element does not have a capability of implementing data offloading, the first network element does not perform offloading transmission on the data, and maintains an original data transmission manner to perform transmission.

This embodiment of the present invention further provides a communications equipment 200, as shown in FIG. 2, including a querying module 201, an acquiring module 202, and a transmitting module 203.

The querying module 201 is configured to query data offloading capability information of a second network element from a server, where the communications equipment has a capability of implementing data offloading.

The acquiring module 202 is configured to receive a message that carries the data offloading capability information of the second network element and is sent by the server.

The transmitting module 203 is configured to offloadingly transmit data which is to be sent when the message indicates that the second network element has a capability of implementing data offloading.

Specifically, the transmitting module 203 is configured to offloadingly transmit data which is to be sent between a first communications system and a second communications system when the message indicates that the second network element has the capability of implementing data offloading.

Exemplarily, when the first communications system is a 3GPP mobile communications system, the second communications system may be a non-3GPP mobile communications system.

Optionally, when the first communications system is a 3GPP mobile communications system, the second communications system may be a short-distance wireless communications system.

Optionally, when the first communications system is a non-3GPP mobile communications system, the second communications system may be a short-distance wireless communications system.

Specifically, when the communications equipment is a user equipment, the second network element is a network equipment set at a radio access network RAN side or a network equipment set at a core network side or a network equipment set at a packet data network side. When the communications equipment is a network equipment set at an RAN side or a network equipment set at a core network side or a network equipment set at a packet data network side, the second network element is a user equipment.

When the second network element is a user equipment, and the first communications system is a wireless communications system, the communications equipment is a network equipment set at an RAN side in the first communications system, or a network equipment set at a core network side in the first communications system, or a network equipment set at a packet data network side in the first communications system.

Exemplarily, when the first communications system may be a GSM or a CDMA2000 system, the communications equipment may be a BSC (Base Station Controller, base station controller) or an MSC (Mobile Switching Center, mobile switching center), or a PDSN (Packet Data Serving Node, packet data serving node).

When the first communications system may be a WCDMA system, the communications equipment may be an RNC (Radio Network Controller, radio network controller), or a GGSN (Gateway GPRS Support Node, gateway GPRS support node), or an SGSN (Serving GPRS Support Node, serving GPRS support node).

When the first communications system may be LTE (Long Term Evolution, long term evolution), the communications equipment may be an eNodeB (Evolved Node B, evolved node B), or an HeNB, or a PGW (Payment Gateway, payment gateway), or an SGW (Signaling Gateway, signaling gateway), or an HeNB GW (Home evolved Node B Gateway, home evolved node B gateway). When the first communications system is Wimax (Worldwide Interoperability for Microwave Access, worldwide interoperability for microwave access), the communications equipment is an ASN (autonomous system, autonomous system) or a CSN (Communications Service Node, communications service node).

A working principle of each module in the communications equipment in this embodiment is the same as that of the method in this embodiment, which is not described herein again.

This embodiment of the present invention provides a communications method and equipment. A data transmission peer end equipment acquires, through querying, data offloading capability information of the equipment by actively sending the data offloading capability information to a server, so that equipments at two sides of data transmission in a network can smoothly perform data offloading transmission through the acquired data offloading capability information, thereby improving an air interface throughput rate of the network.

### Embodiment 2

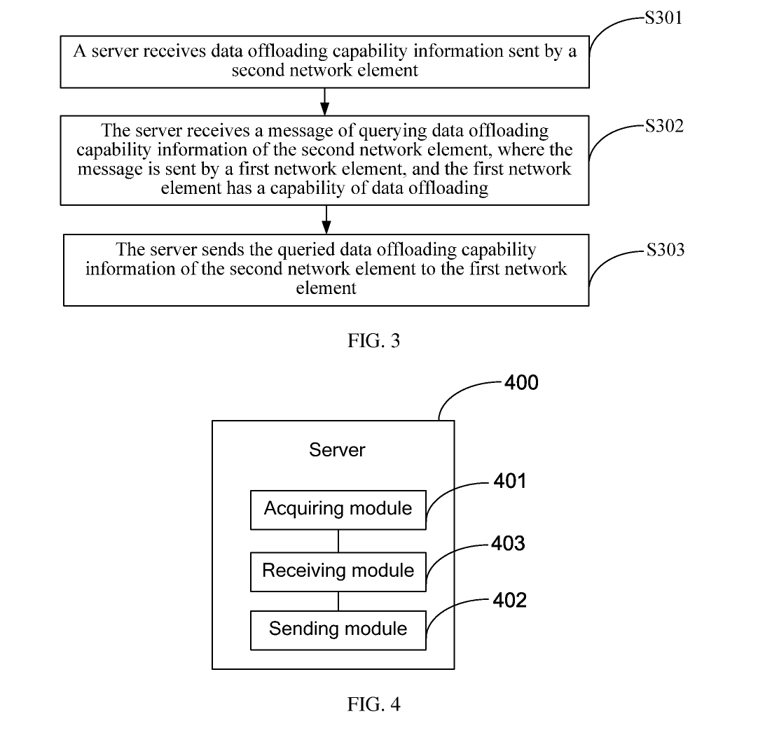

An embodiment of the present invention provides another communications method. The method is a server side method. As shown in FIG. 3, the method includes:

S301: A server receives data offloading capability information sent by a second network element.

In order to implement data offloading transmission, a first network element and a second network element at two sides of data transmission need to have a capability of implementing data offloading, and the first network element and the second network element at the two sides of the data transmission can acquire data offloading transmission capability information of each other. That the first network element and the second network element have a capability of implementing data offloading means that the first network element and the second network element can perform data offloading transmission between a first communications system and a second communications system, so as to distribute a part of data transmitted in the first communications system to the second communications system for synchronous data transmission. The data offloading transmission capability information refers to one of the following or a combination message of the following: enabling status information of a data offloading function, network offloading setting information, and terminal data offloading service IP address or service port number information of the first network element or the second network element.

In this embodiment of the present invention, firstly the second network element is enabled to send data offloading information to a server, where the server may be deployed in a PDN network, and may also be deployed in a CN network, and is mainly configured to store data offloading capability information of a user equipment and a network equipment in a long term.

There are mainly two approaches in which the second network element sends the data offloading capability information to the server:

A first approach is the data offloading capability information is actively sent to the server by the second network element.

In an active sending approach, exemplarily, when the second network element is a network equipment set at a radio access network RAN side, and when the second network element completes network deployment or when a data offloading capability of the second network element changes, the second network element actively sends the data offloading capability information to the server. When the second network element is a user equipment, and when the second network element starts a network function for the first time, or when a data offloading capability of the second network element changes, the second network element actively sends the data offloading capability information to the server.

A second approach is the data offloading capability information of the second network element is sent to the server by the second network element in response to a request.

Specifically, when the server does not include to-be-queried data offloading information of the second network element after the first network element queries the data offloading capability information of the second network element from the server, the first network element or the server may send a request to the second network element, so that the second network element sends the data offloading information to the server in response to the request.

S302: The server receives a message of querying data offloading capability information of the second network element, where the message is sent by the first network element, and the first network element has a capability of implementing data offloading.

In this embodiment of the present invention, before the first network element queries a data offloading capability of the second network element from the server, a communications system connection should be established between the first network element and the second network element. Exemplarily, when the first network element is a user equipment, and the second network element is a network equipment set at an RAN side, after entering a network cell where the second network element is located, the user equipment establishes an EPS/SAE bearer connection with the network cell where the second network element is located.

After a communications system connection is established between the first network element and the second network element, the first network element may query the data offloading capability information of the second network element from the server. Specifically, the first network element may send an instruction of querying a data offloading capability of the second network element to the server to instruct the server to query the data offloading capability information of the second network element.

The server starts a querying process after receiving a message of querying the data offloading capability information of the second network element, where the message is sent by the first network element. When the server obtains, through querying, the data offloading capability information of the second network element required by the first network element, the server directly sends the data offloading capability information to the first network element. When the server does not obtain, through querying, the data offloading capability information of the second network element required by the first network element, the server may have two solutions:

The first one is directly send a request instruction to the second network element queried by the first network element, so that the second network element sends the data offloading capability information to the server, and the server stores the data offloading capability information of the second network element and forwards the data offloading capability information to the first network element.

The second one is the server sends, to the first network element, a situation that the data offloading capability information of the second network element required by the first network element is not obtained through querying, the first network element directly sends a data offloading function connection to the second network element, or instructs the second network element to send the data offloading capability information to the server, and the server stores the data offloading capability information of the second network element and forwards the data offloading capability information to the first network element.

It should be noted that, in this embodiment of the present invention, the first network element has a capability of implementing data offloading, and the first network element can perform data offloading transmission between the first communications system and the second communications system, so as to distribute a part of data transmitted in the first communications system to the second communications system for synchronous data transmission. The data offloading transmission capability information refers to one of the following or a combination message of the following: enabling status information of a data offloading function, network offloading setting information, and terminal data offloading service IP address or service port number information of the first network element or the second network element.

In this embodiment, when the first communications system is a 3GPP mobile communications system, the second communications system may be a non-3GPP mobile communications system.

Optionally, when the first communications system is a 3GPP mobile communications system, the second communications system may be a short-distance wireless communications system.

Optionally, when the first communications system is a non-3GPP mobile communications system, the second communications system may be a short-distance wireless communications system.

In this embodiment, the first network element may be a user equipment, and the second network element may be a network equipment set at an RAN side or a network equipment set at a core network side or a network equipment set at a packet data network side. The first network element may also be a network equipment set at an RAN side or a network equipment set at a core network side or a network equipment set at a packet data network side, and the second network element is a user equipment.

S303: The server sends the queried data offloading capability information of the second network element to the first network element, so as to perform data offloading transmission.

Specifically, the server sends the queried or the acquired data offloading capability information of the second network element to the first network element, so that the first network element performs data offloading transmission according to the data offloading capability information of the second network element.

As shown in FIG. 4, this embodiment of the present invention provides a server 400, including: an acquiring module 401, a sending module 402, and a receiving module 403.

The acquiring module 401 is configured to acquire a message of querying data offloading capability information of a second network element, where the message is sent by a first network element, and the first network element has a capability of implementing data offloading.

The sending module 402 is configured to send queried data offloading capability information of the second network element to the first network element, so as to perform data offloading transmission.

The receiving module 403 is configured to receive data offloading capability information sent by the second network element.

Specifically, the receiving module 403 is configured to receive data offloading capability information actively sent by the second network element when the second network element completes network deployment or when a data offloading capability of the second network element changes; or receive data offloading capability information sent by the second network element in response to a request of the server or the first network element.

A working principle of each module of the server in this embodiment is the same as that of the method in this embodiment, which is not described herein again.

This embodiment of the present invention provides a communications method and a server. After a message that a first network element queries data offloading capability information of a second network element is received, the queried data offloading capability information of the second network element is sent to the first network element, so as to perform data offloading transmission, so that a data transmission peer end equipment acquires, through querying, data offloading capability information of the equipment, and therefore equipments at two sides of data transmission in a network can smoothly perform data offloading transmission through the acquired data offloading capability information, thereby improving an air interface throughput rate of the network.

### Embodiment 3

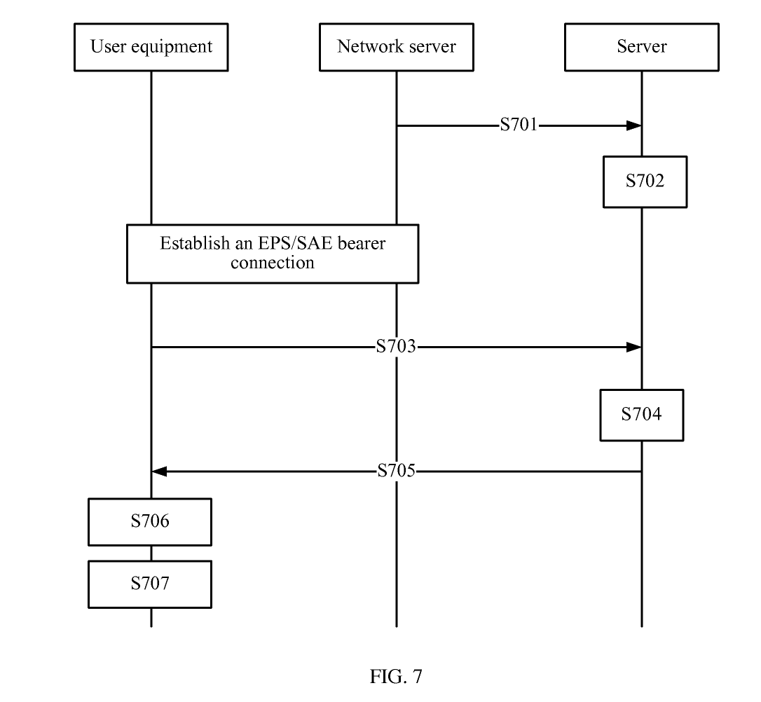

Another communications method provided in an embodiment of the present invention is described in the following with reference to FIG. 7. An application scenario of this embodiment is as follows.

A first network element is a user equipment, and a second network element is a network equipment set at an RAN side. Steps of the method include:

S701: The network equipment sends data offloading capability information to a server.

When the network equipment completes network deployment, or when a data offloading capability of the network equipment changes, the network equipment actively sends the data offloading capability information to the server.

Or, the network equipment sends the data offloading capability information in response to a request of the server or the user equipment.

S702: The server receives the data offloading capability information sent by the network equipment.

S703: The user equipment queries the data offloading capability information of the network equipment from the server, where the user equipment has a capability of implementing data offloading.

In this embodiment of the present invention, before the user equipment queries the data offloading capability of the network equipment from the server, a communications system connection should be established between the user equipment and the network equipment. After entering a network cell where the network equipment is located, the user equipment establishes an EPS/SAE bearer connection with the network cell where the network equipment is located.

S704: The server receives a message of querying the data offloading capability information of the network equipment, where the message is sent by the user equipment.

The server starts a querying process after receiving the message of querying the data offloading capability information of the network equipment, where the message is sent by the user equipment.

S705: The server sends the queried data offloading capability information of the network equipment to the user equipment.

S706: The user equipment receives a message that carries the data offloading capability information of the network equipment and is sent by the server.

S707: The user equipment performs offloading transmission on data when the message indicates that the network equipment has a capability of implementing data offloading.

This embodiment of the present invention provides a communications method. After a message that a user equipment queries data offloading capability information of a network equipment is received, the queried data offloading capability information of the network equipment is sent to the user equipment, so as to perform data offloading transmission, so that a data transmission peer end user equipment acquires, through querying, the data offloading capability information of the network equipment, and therefore equipments at two sides of data transmission in a network can smoothly perform data offloading transmission through the acquired data offloading capability information, thereby improving an air interface throughput rate of the network.

### Embodiment 4

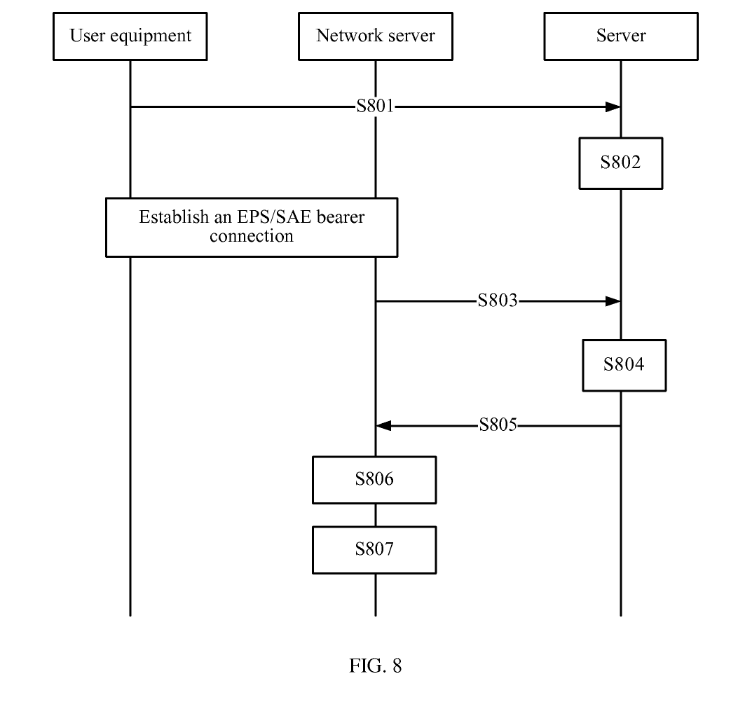

As shown in FIG. 8, another communications method provided in an embodiment of the present invention is described. An application scenario of this embodiment is as follows.

A first network element is a network equipment set at an RAN side, and a second network element is a user equipment. Steps of the method include:

S801: The user equipment sends data offloading capability information to a server.

When the user equipment starts a network for the first time, or when a data offloading capability of the user equipment changes, the user equipment actively sends the data offloading capability information to the server.

Or, the server receives the data offloading capability information sent by the user equipment, that is, the second network element, in response to a request of the server or the network equipment.

S802: The server receives the data offloading capability information sent by the user equipment.

S803: The network equipment queries the data offloading capability information of the user equipment from the server, where the network equipment has a capability of implementing data offloading.

In this embodiment of the present invention, before the network equipment queries the data offloading capability of the user equipment from the server, a communications system connection should be established between the network equipment and the user equipment. After entering a network cell where the network equipment is located, the user equipment establishes an EPS/SAE bearer connection with the network cell where the network equipment is located.

S804: The server receives a message of querying the data offloading capability information of the user equipment, where the message is sent by the network equipment.

The server starts a querying process after receiving the message of querying the data offloading capability information of the user equipment, where the message is sent by the network equipment.

S805: The server sends the queried data offloading capability information of the user equipment to the network equipment, so as to perform data offloading transmission.

S806: The network equipment receives a message that carries the data offloading capability information of the user equipment and is sent by the server.

S807: The network equipment performs offloading transmission on data when the message indicates that the user equipment has a capability of implementing data offloading.

This embodiment of the present invention provides a communications method. After a message that a network equipment queries data offloading capability information of a user equipment is received, the queried data offloading capability information of the user equipment is sent to the network equipment, so as to perform data offloading transmission, so that a data transmission peer end network equipment acquires, through querying, the data offloading capability information of the user equipment, and therefore equipments at two sides of data transmission in a network can smoothly perform data offloading transmission through the acquired data offloading capability information, thereby improving an air interface throughput rate of the network.

### Embodiment 5

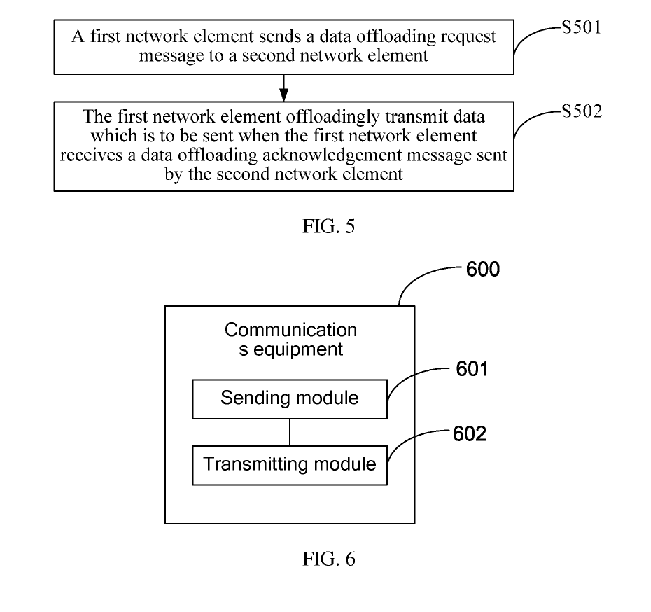

An embodiment of the present invention provides another communications method. The method is a first network element side method. It may be understood that, in this embodiment of the present invention, a first network element and a second network element are in a peer relationship. When the first network element is a user equipment, the second network element is a network side equipment. When the first network element is a network side equipment, the second network element is a user equipment. In this embodiment of the present invention, when one of the foregoing is taken as an example for description, the other is a corresponding method, which is not described herein again. As shown in FIG. 5, the method includes:

S501: The first network element sends a data offloading request message to the second network element.

In order to implement data offloading transmission, a first network element and a second network element at two sides of data transmission need to acquire data offloading transmission capability information of each other, so as to perform data offloading transmission according to the acquired data offloading transmission information to distribute a part of data to a non-current communications system, so that synchronous transmission is performed on data in two types of communications systems, thereby improving a transmission rate of a network.

In this embodiment, in order to acquire each other's data offloading transmission capability information of the first network element and the second network element at two sides of data transmission, the first network element may directly send a data offloading request message to the second network element. The first network element should have a data offloading transmission capability.

It should be noted that, in this embodiment of the present invention, the first network element has a capability of implementing data offloading, and the first network element can perform data offloading transmission between a first communications system and a second communications system, so as to distribute a part of data transmitted in the first communications system to the second communications system for synchronous data transmission. The data offloading transmission capability information refers to one of the following or a combination message of the following: enabling status information of a data offloading function, network offloading setting information, and terminal data offloading service IP address or service port number information of the first network element or the second network element.

In this embodiment, when the first communications system is a 3GPP mobile communications system, the second communications system may be a non-3GPP mobile communications system.

Optionally, when the first communications system is a 3GPP mobile communications system, the second communications system may be a short-distance wireless communications system.

Optionally, when the first communications system is a non-3GPP mobile communications system, the second communications system may be a short-distance wireless communications system.

In this embodiment, the first network element may be a user equipment, and the second network element may be a network equipment set at an RAN side or a network equipment set at a core network side or a network equipment set at a packet data network side. The first network element may also be a network equipment set at an RAN side or a network equipment set at a core network side or a network equipment set at a packet data network side, and the second network element is a user equipment.

Before the first network element directly sends a data offloading request message to the second network element, a communications system connection is established between the first network element and the second network element. Exemplarily, a communications system connection may mean that the first network element and the second network element establish a PDP (Packet Data Protocol, packet data protocol) connection and keep an RRC connection (Radio Resource Control, radio resource control protocol).

After a communications system connection is established between the first network element and the second network element, the first network element may send a data offloading request message to the second network element.

Preferably, when the first network element may send the data offloading request message to the second network element by setting a mode of sending the data offloading request message at regular time, and when the first network element does not receive, in preset time, the data offloading acknowledgement message sent by the second network element, the first network element resends the data offloading request message to the second network element. When the number of times of resending the data offloading request message by the first network element reaches the preset number of times, the first network element stops resending the data offloading request message to the second network element.

S502: The first network element offloadingly transmits data which is to be sent when the first network element receives a data offloading acknowledgement message sent by the second network element.

There are mainly two situations when the first network element receives the data offloading acknowledgement message sent by the second network element.

A first situation is when the second network element is a user equipment, the first network element is a network equipment set at a radio access network RAN side or a network equipment set at a core network side or a network equipment set at a packet data network side:

If the second network element has a data offloading capability, after receiving the data offloading request message sent by the first network element, the second network element sends one of the following or a combination message of the following: a data offloading acknowledgement message of enabling status information of a data offloading function, a data offloading acknowledgement message of preference setting of network offloading, and a data offloading acknowledgement message of a terminal data offloading virtual IP address and/or service port number of the second network element to the first network element.

But, if the second network element does not have a data offloading capability, the second network element does not reply. When the number of sending times of the first network element reaches the preset number of times of sending the data offloading request message, the first network element stops resending the data offloading request message to the second network element, and considers by default that the second network element does not have a data offloading capability.

A second situation is when the second network element is a network equipment set at a radio access network RAN side or a network equipment set at a core network side or a network equipment set at a packet data network side, the first network element is a user equipment:

If the second network element has a data offloading capability and when the second network element receives the data offloading request message of the first network element, the second network element sends a data offloading acknowledgement message to the first network element when a load can bear a data offloading function. The data offloading acknowledgement message includes an enabling status of the data offloading function, a data offloading policy, a service port number, a offloading network access identifier, and a key of the second network element.

If the second network element has a data offloading capability, but when the second network element receives the data offloading request message of the first network element, a network cannot bear a data offloading function, the second network element replies with an acknowledgement message that establishment of data offloading is not supported, so that the first network element receives information that the second network element cannot bear the data offloading.

But, if the second network element does not have a data offloading capability, the second network element does not reply. When the number of sending times of the first network element reaches the preset number of times of sending the data offloading request message, the first network element stops resending the data offloading request message to the second network element, and considers by default that the second network element does not have a data offloading capability.

As shown in FIG. 6, this embodiment of the present invention provides a communications equipment 600, including: a sending module 601 and a transmitting module 602, where the sending module 601 is configured to send a data offloading request message to a second network element, and the transmitting module 602 is configured to offloadingly transmit data which is to be sent when the communications equipment receives a data offloading acknowledgement message sent by the second network element.

Specifically, the transmitting module is further configured to resend the data offloading request message to the second network element when the communications equipment does not receive, in preset time, the data offloading acknowledgement message sent by the second network element.

A working principle of each module in the communications equipment in this embodiment is the same as that of the method in this embodiment, which is not described herein again.

This embodiment of the present invention provides a communications method and equipment. Data offloading capability information of equipments at two sides of data transmission in a network is acquired through active query, so that the equipments at two sides of data transmission in the network can smoothly perform data offloading transmission through the acquired data offloading capability information, thereby improving an air interface throughput rate of the network.

### Embodiment 6

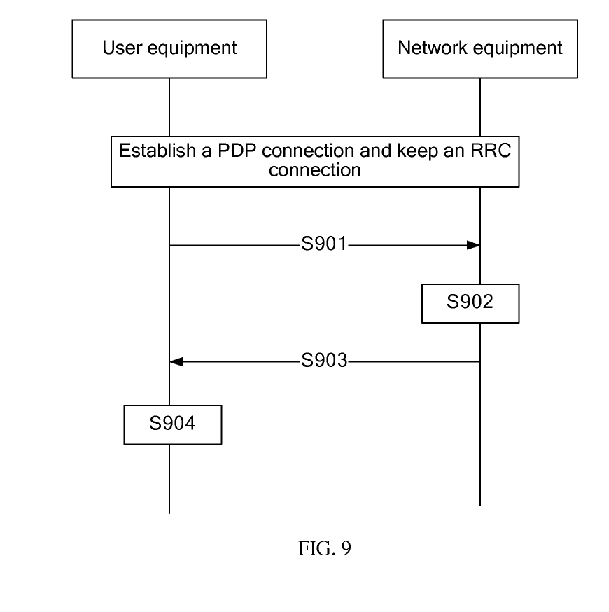

Another communications method provided in an embodiment of the present invention is described in the following with reference to FIG. 9. An application scenario of this embodiment is as follows.

A first network element is a user equipment, and a second network element is a network equipment set at a data offloading network side. Steps of the method include:

S901: The user equipment sends a data offloading request message to the network equipment.

After the user equipment and the network equipment establish a PDP connection and keep an RRC connection, the user equipment may send the data offloading request message to the network equipment.

S902: The network equipment receives the data offloading request message sent to the network equipment by the user equipment.

S903: The network equipment sends a data offloading request message to the user equipment when the network equipment has a data offloading capability.

After receiving the data offloading request message sent by the user equipment, the network equipment sends one of the following or a combination message of the following: a data offloading acknowledgement message of enabling status information of a data offloading function, a data offloading acknowledgement message of preference setting of network offloading, and a data offloading acknowledgement message of a terminal data offloading virtual IP address or service port number of the network equipment to the user equipment.

S904: The user equipment offloadingly transmits data which is to be sent when the user equipment receives a data offloading acknowledgement message sent by the network equipment.

This embodiment of the present invention provides a communications method. In the method, when a first network element is a user equipment, a second network element is a network equipment, and the first network element and the second network element may be in a peer relationship. In this embodiment of the present invention, one of the foregoing is taken as an example for description, the other is a corresponding method, which is not described herein again.

This embodiment of the present invention provides a communications method. Data offloading capability information of equipments at two sides of data transmission in a network is acquired through active query, so that the equipments at two sides of data transmission in the network can smoothly perform data offloading transmission through the acquired data offloading capability information, thereby improving an air interface throughput rate of the network.

Persons of ordinary skill in the art may understand that all or part of the steps of the foregoing method embodiments may be implemented by a program instructing relevant hardware. The foregoing program may be stored in a computer readable storage medium. When the program is run, the steps of the foregoing embodiments are performed. The foregoing storage medium may be any medium capable of storing program codes, such as a ROM, a RAM, a magnetic disk, or an optical disk.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A communications method, comprising:
querying, by a first network element, data offloading capability information of a second network element from a server, wherein the first network element has a capability of data offloading;
receiving, by the first network element, a message that carries the data offloading capability information of the second network element and is sent by the server; and
offloadingly transmitting, by the first network element, data which is to be sent when the message indicates that the second network element has the capability of data offloading.

2. The method according to claim 1, wherein:
the first network element is a user equipment, and the second network element is a network equipment set at a radio access network (RAN) side or a network equipment set at a core network side or a network equipment set at a packet data network side; or
the first network element is a network equipment set at an RAN side or a network equipment set at a core network side or a network equipment set at a packet data network side, and the second network element is a user equipment.

3. The method according to claim 1, wherein the data offloading capability information of the second network element is actively sent to the server by the second network element, or, the data offloading capability information of the second network element is sent to the server by the second network element in response to a request.

4. The method according to claim 1, wherein the offloadingly transmitting, by the first network element, the data which is to be sent, comprises offloadingly transmitting, by the first network element, the data which is to be sent in a first communications system and a second communications system.

5. The method according to claim 4, wherein:
the first communications system is a 3GPP mobile communications system, and the second communications system is a non-3GPP mobile communications system; or,
the first communications system is a 3GPP mobile communications system, and the second communications system is a short-distance wireless communications system; or
the first communications system is a non-3GPP mobile communications system, and the second communications system is a short-distance wireless communications system.

6. The method according to claim 5, wherein, when the first network element or the second network element is a user equipment, and the first communications system is a wireless communications system, the user equipment is located in a macro cell, a micro cell, a pico cell, or a femto cell of the first communications system.

7. The method according to claim 1, wherein the data offloading capability information comprises one of the following or a combination of the following: enabling status information of a data offloading function, network offloading setting information, and a terminal data offloading service IP address or a service port number information of the second network element.

8. A communications equipment, comprising:
a querying module, configured to query data offloading capability information of a second network element from a server, wherein the communications equipment has a capability of data offloading;
an acquiring module, configured to receive a message that carries the data offloading capability information of the second network element and is sent by the server; and
a transmitting module, configured to offloadingly transmit data which is to be sent when the message indicates that the second network element has a capability of implementing data offloading.

9. The equipment according to claim 8, wherein:
the communications equipment is a user equipment, and the second network element is a network equipment set at a radio access network (RAN) side or a network equipment set at a core network side or a network equipment set at a packet data network side; or
the communications equipment is a network equipment set at an RAN side or a network equipment set at a core network side or a network equipment set at a packet data network side, and the second network element is a user equipment.

10. The equipment according to claim 8, wherein, the transmitting module is specifically configured to offloading transmission the data which is to be sent between a first communications system and a second communications system when the message indicates that the second network element has the capability of data offloading.

11. The equipment according to claim 10, wherein:
the first communications system is a 3GPP mobile communications system, and the second communications system is a non-3GPP mobile communications system; or,
the first communications system is a 3GPP mobile communications system, and the second communications system is a short-distance wireless communications system; or
the first communications system is a non-3GPP mobile communications system, and the second communications system is a short-distance wireless communications system.

12. The equipment according to claim 11, wherein, when the second network element is a user equipment, and the first communications system is a wireless communications system, the communications equipment is a network equipment set at an RAN side of the first communications system, or a network equipment set at a core network side of the first communications system, or a network equipment set at a packet data network side of the first communications system.

13. The equipment according to claim 12, wherein, when the first communications system is a GSM or a CDMA2000 system, the communications equipment is a BSC, or an MSC, or a PDSN; when the first communications system is a WCDMA system, the communications equipment is an RNC, or a GGSN, or an SGSN; when the first communications system is LTE system, the communications equipment is an eNodeB, or an HeNB, or a PGW, or an SGW, or an HeNB GW; and when the first communications system is a Wimax system, the communications equipment is an ASN, or a CSN.

14. A communications method, comprising:
receiving, by a server, a message of querying data offloading capability information of a second network element, wherein the message is sent by a first network element, and the first network element has a capability of data offloading; and
sending, by the server, the queried data offloading capability information of the second network element to the first network element.

15. The method according to claim 14, further comprising:
receiving, by the server, data offloading capability information sent by the second network element.

16. The method according to claim 15, wherein the receiving, by the server, data offloading capability information sent by the second network element comprises:
receiving, by the server, data offloading capability information actively sent by the second network element when the second network element completes network deployment or when a data offloading capability of the second network element changes; or,
receiving, by the server, data offloading capability information sent by the second network element in response to a request of the server or the first network element.

17. A server, comprising:
an acquiring module, configured to receive a message of querying data offloading capability information of a second network element, wherein the message is sent by a first network element, and the first network element has a capability of implementing data offloading; and
a sending module, configured to send the queried data offloading capability information of the second network element to the first network element.

18. The server according to claim 17, further comprising:
a receiving module, configured to receive data offloading capability information sent by the second network element.

19. The server according to claim 18, wherein the receiving module is specifically configured to receive data offloading capability information actively sent by the second network element when the second network element completes network deployment or when a data offloading capability of the second network element changes; or receive data offloading capability information sent by the second network element in response to a request of the server or the first network element.

20. A communications method, comprising:
sending, by a first network element, a data offloading request message to a second network element; and
offloadingly transmitting, by the first network element, data which is to be sent when the first network element receives a data offloading acknowledgement message sent by the second network element.

21. The method according to claim 20, further comprising:
resending, by the first network element, the data offloading request message to the second network element when the first network element does not receive, in preset time, the data offloading acknowledgement message sent by the second network element.

22. The method according to claim 21, further comprising:
stopping, by the first network element, resending the data offloading request message to the second network element when a number of times of resending the data offloading request message by the first network element reaches a preset number of times.

23. The method according to claim 20, wherein, the sending, by the first network element, the data offloading request message to the second network element comprises:
sending, by the first network element, the data offloading request message to the second network element after the first network element and the second network element establish a packet data connection (PDP) connection and keep a Radio Resource Control (RRC) protocol connection.

24. A communications equipment, comprising:
a sending module, configured to send a data offloading request message to a second network element; and
a transmitting module, configured to offloadingly transmit data which is to be sent when the communications equipment receives a data offloading acknowledgement message sent by the second network element.

25. The communications equipment according to claim 24, wherein, the transmitting module is further configured to resend the data offloading request message to the second network element when the communications equipment does not receive, in preset time, the data offloading acknowledgement message sent by the second network element.
